(19) United States
(12) Patent Application Publication
(10) Pub. No.: US 2014/0244828 A1
(43) Pub. Date: Aug. 28, 2014

(54) METHODS AND APPARATUS TO MEASURE EXPOSURE TO STREAMING MEDIA

(71) Applicant: Jan Besehanic, Tampa, FL (US)

(72) Inventor: Jan Besehanic, Tampa, FL (US)

(21) Appl. No.: 13/778,108

(22) Filed: Feb. 26, 2013

(51) Int. Cl. H04L 12/26

(52) U.S. Cl. CPC H04L 43/04
USPC 709/224

(57) ABSTRACT

Methods and apparatus to measure exposure to streaming media are disclosed. An example method includes inspecting a HyperText Transfer Protocol (HTTP) request directed to a service provider to determine whether the HTTP request includes a fragment identifier. Media-identifying metadata is extracted from the fragment identifier. The media-identifying metadata is transmitted to a central facility, the central facility at a location different from the service provider.

### FIELD OF THE DISCLOSURE

This disclosure relates generally to measuring media exposure, and, more particularly, to methods and apparatus to measure exposure to streaming media.

### BACKGROUND

Internet access to media has become widespread. Media is now frequently streamed to consumers via streaming services such as, Netflix™, Hulu™, and others. Streaming enables media to be delivered to and presented by a wide variety of media devices, such as a digital versatile disc (DVD) player, a smart TV, an Apple TV®, a Roku™ media player, a Boxee™ media player, a Sony PlayStation™, a Microsoft® Xbox®, an Apple iPad®, etc. A significant portion of media (e.g., content and/or advertisements) is presented via streaming to such devices.

### BRIEF DESCRIPTION OF THE DRAWINGS

FIG. 1 is a block diagram of an example system constructed in accordance with the teachings of this disclosure for measuring exposure to streaming media.

FIGS. 2-4 are a block diagrams of example configurations of the network devices shown in FIG. 1.

FIG. 5 is a block diagram of an example implementation of the example media monitor of FIG. 1.

FIG. 6 is a block diagram of an example implementation of an example HLS stream that may be delivered to the example media devices of FIG. 1.

FIG. 7 illustrates an example manifest describing the example HLS stream of FIG. 6 that may be used by the example media devices of FIG. 1.

FIG. 7A illustrates an example HTTP request that may be transmitted by the example media devices of FIG. 1.

FIG. 8 is a flowchart representative of example machine-readable instructions which may be executed to implement the example service provider of FIG. 1, the example media device(s) of FIG. 1, the example media monitor of FIG. 1, and/or the example central facility of FIG. 1.

FIG. 9 is a flowchart representative of example machine-readable instructions which may be executed to implement the example service provider of FIG. 1.

FIG. 10 is a flowchart representative of example machine-readable instructions which may be executed to implement the example media monitor of FIG. 1.

FIG. 11 is a flowchart representative of example machine-readable instructions which may be executed to implement the example media monitor of FIG. 1.

FIG. 12 is a flowchart representative of example machine-readable instructions which may be executed to implement the example central facility of FIG. 1.

FIG. 13 is a block diagram of an example processor platform capable of executing the example machine-readable instructions of FIGS. 8, 9, 10, 11, and/or 12 to implement the example service provider of FIG. 1, the example media monitor of FIG. 1, and/or the example central facility of FIG. 1.

The figures are not to scale. Wherever possible, the same reference numbers will be used throughout the drawing(s) and accompanying written description to refer to the same or like parts.

### DETAILED DESCRIPTION

Example methods, apparatus, systems, and articles of manufacture disclosed herein may be used to measure exposure to streaming media. Some such example methods, apparatus, and/or articles of manufacture measure such exposure based on media metadata, user demographics, and/or media device types. Some examples disclosed herein may be used to monitor streaming media transmissions received at media devices adapted to receive streaming media such as a DVD player, a Smart TV, an Apple TV®, a Roku™ media player, a Boxee™ media player, a Sony PlayStation™, a Microsoft® Xbox®, an Apple iPad®, and/or any other device capable of playing media. Example monitoring processes disclosed herein collect media metadata from network communications associated with streaming media presented via such media devices and associate the metadata with demographic information of users of the media devices. In this manner, detailed exposure metrics are generated based on collected media metadata and associated user demographics.

The use of media devices (e.g., a DVD player, an Apple TV®, a Roku™ media player, a Boxee™ media player, a Sony PlayStation™, a Microsoft® Xbox®, an Apple iPad®, etc.) to present streaming media available via the Internet has increased in recent years. As different types of media applications (e.g., a Netflix™ application, a Hulu™ application, a Pandora™ application, etc.) for such media devices have been created, the popularity of streaming media has increased. Indeed, some households have eliminated traditional sources of media (e.g., satellite television, cable television) in favor of such streaming devices. In view of the increasing popularity of accessing media in this manner, understanding how users interact with the streaming media (e.g., such as by understanding what media is presented, how the media is presented, who is accessing such media, etc.) provides valuable information to service providers, advertisers, content providers, manufacturers, and/or other entities.

In some disclosed examples, a media device structured to access streaming media includes a network interface to transmit a request for the streaming media to be presented by the media device. In such examples, the media device requests content from a content provider via a network (e.g., the Internet). In some examples, the request for content is a HyperText Transfer Protocol (HTTP) request, a Session Initiation Protocol (SIP) message, a domain name service (DNS) query, a file transfer protocol (FTP) request, and/or any other type of request for content. As disclosed herein, such network communications may be monitored to identify media-identifying metadata included therein.

Some networks utilize Internet Protocol (IP) for communication. The IP address scheme utilizes IP addresses assigned to network devices. For example, a network device might be assigned an IP version 4 (IPv4) address of 192.168.0.2. Any other past, present, and or future addressing scheme may additionally or alternatively be used such as, for example, a media access control (MAC) address, an IP version 6 (IPv6) address. In some examples, more than one IP address might be associated with a network device. For example, at a first time, the network device might be identified by an IP address of 192.168.0.2, while at a second time, the network device might be identified by an IP address of 192.168.0.3. Changing IP addresses may occur when a device is moved from location to location and/or when the device is in a dynamic IP addressing system. Such addresses may be used to identify the media device used to present the media.

To provide streaming media, media is received at a service provider from a media provider such as, for example, a satellite provider, a cable provider, a physical media provider (e.g., a Digital Versatile Disk (DVD)-by-mail service, etc.). The media is intended to be streamed from the service provider to one or more media devices for presentation thereon in response to the request for the same. In the illustrated example, the media is provided to the media devices as a transport stream. In some examples, metering data having a first format is extracted from the transport stream at the media presentation site (e.g., a monitored panelist location). In some such examples, the transport stream corresponds to a Moving Picture Experts Group (MPEG) 2 transport stream sent according to a hypertext transfer protocol (HTTP) live streaming (HLS) protocol. However, the transport stream may additionally or alternatively correspond to and/or be sent according to any other past, present, or future protocol and/or format such as, for example, MPEG 4, an HTTP Secure protocol (HTTPS), a file transfer protocol (FTP), a secure file transfer protocol (SFTP).

Audio watermarking is a technique used to identify media such as television broadcasts, radio broadcasts, advertisements (television and/or radio), downloaded media, streaming media, prepackaged media, etc. Existing audio watermarking techniques identify media by embedding audio codes (e.g., a watermark), such as media identifying information and/or an identifier that may be mapped to media identifying information, into an audio and/or video component having a signal characteristic sufficient to hide the watermark. As used herein, the terms “code” or “watermark” are used interchangeably and are defined to mean any identification information (e.g., an identifier) that may be inserted or embedded in the audio or video of media (e.g., a program or advertisement) for the purpose of identifying the media or for another purpose such as tuning (e.g., a packet identifying header). As used herein “media” refers to audio and/or visual (still or moving) content and/or advertisements. To identify watermarked media, the watermark(s) are extracted and compared to reference watermarks that are mapped to media identifying information.

Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation, but that is unique relative to other (e.g., different) presentations of other (e.g., different) media. Accordingly, the term “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature.

In some disclosed examples, streaming media is delivered to the media device using HTTP Live Streaming (HLS). However, any other past, present, and/or future protocol(s) and/or method(s) of streaming media to the media device may additionally or alternatively be used such as, for example, an HTTP Secure (HTTPS) protocol, a custom application, etc. Additionally or alternatively, any other past, present, and/or future web page language may additionally or alternatively be used. The HyperText Markup Language version 5 (HTML5) allows metadata to be included in a fragment identifier included in a universal resource locator (URL) and/or otherwise associated with, for example, a media stream, etc. In some disclosed examples, a media device uses an application to display media received via HLS. Additionally or alternatively, in some disclosed examples the media device uses a media presenter (e.g., a browser plugin, an app, a framework, an application programming interface (API), etc.) to display media received via HLS.

Some example methods, apparatus, and articles of manufacture disclosed herein inspect the network communications of the media devices to determine if the network communications should be recorded. For example, when the media monitor identifies HTTP requests that include a fragment identifier including media-identifying metadata, the network communications are transmitted to a network activity measurement system and/or stored for transmission to the network activity measurement system at a later time. Some such example methods, apparatus, and articles of manufacture additionally or alternatively determine ownership and/or usage statistics based on messages from the WAN to the media devices on the LAN. Some example methods, apparatus, and articles of manufacture disclosed herein determine the type(s) of media device based on the network communications (e.g., via HTTP queries contained in the communications, via identifiers of the media device (e.g., a MAC address) included in the communications, by using an Address Resolution Protocol to look up a hardware address of a media device, etc.). However, unlike media providers that track usage statistics, the media monitor does not return media to the media device(s) in response to the network communications.

In examples illustrated herein, the media device requests the web page from a service provider. In examples illustrated herein, the webpage defines a manifest file that identifies media segments to be retrieved by the media device. The manifest file identifies media segments using one or more URLs that respectively include a fragment identifier. A fragment identifier is a portion of a URL that enables identification of a resource other than the URL being requested (e.g., a section of a webpage). In some examples, a fragment identifier may identify a resource within the item being requested. For example, a URL for a webpage that includes a fragment identifier may cause a browser to display a section of the website identified by the fragment identifier. In examples disclosed herein, the fragment identifier is used to identify the streaming media. That is, the fragment identifier contains media-identifying metadata that may facilitate identification of the media. In some examples, other information is included in the fragment identifier such as, for example, an identifier of the service provider, an identifier of the media device, an identifier of a panelist associated with the media device, etc. In examples disclosed herein, the fragment identifier is delimited from the remainder of the URL using a hash “#”. However, any other character and/or group of characters may additionally or alternatively be used. Furthermore, while in the illustrated example the fragment identifier is included as part of the URL, the fragment identifier may be included in any other portion of the request such as, for example, in a host field of an HTTP request, a referrer field of an HTTP request, etc.

To link demographics to the monitoring information, the audience measurement entity establishes a panel of users who have agreed to provide their demographic information and to have their streaming media activities monitored. When an individual joins the panel, they provide detailed information concerning their identity and demographics (e.g., gender, race, income, home location, occupation, etc.) to the audience measurement entity. In some examples, the audience measurement entity sends (e.g., via postal mail) a media monitor to be configured intermediate a media device and a display (e.g., a television). In particular, the media monitor provided to each panelist reports access(es) to streamed media in substantially real time to a central facility of the audience measurement entity. In some examples, the media monitor reports access(es) to streamed media as the access(es) occur (e.g., streaming). In some examples, the media monitor caches (e.g., stores, buffers, etc.) the access(es) to streamed media and transmits the cached access(es) to the central facility.

Example methods, apparatus, systems, and articles of manufacture disclosed herein may also be used to generate reports indicative of media exposure metrics on one or more different types of streaming media devices (e.g., a Smart TV, a DVD player, an Apple TV®, a Roku™ media player, a Boxee™ media player, a Sony PlayStation™, Microsoft® Xbox®, a tablet PC, an Apple iPad®, etc.). For example, an audience measurement entity may generate media exposure metrics based on metadata extracted from the streaming media at the media device and/or similar devices and/or audience identification information collected at the media presentation site. A report is then generated based on the media exposure to indicate exposure measurements (e.g., for a type of media (e.g., a genre)) using different types of media devices. Thus, for example, reports indicating the popularity of watching, for instance, sports events on certain types of media devices (e.g., streaming devices) can be compared to other popularities of watching sports events on other types of media devices (e.g., televisions that are not enabled for streaming).

Additionally or alternatively, popularities of different types of media across different device types may be compared. Such different types of media may be, for example, news, movies, television programming, on-demand media, Internet-based media, games, streaming games, etc. Such comparisons may be made across any type(s) and/or numbers of devices including, for example, cell phones, smart phones, dedicated portable multimedia playback devices, iPod® devices, tablet computing devices (e.g., an iPad®, etc.), standard-definition (SD) televisions, high-definition (HD) televisions, three-dimensional (3D) televisions, stationary computers, portable computers, streaming media devices, Internet radios, etc. Any other type(s) and/or number of media and/or devices may be analyzed. The report may also associate the media exposure metrics with demographic segments (e.g., age groups, genders, ethnicities, etc.) corresponding to the user(s) of the media device(s). Additionally or alternatively, the report may include metric indicators of popularity of artist, genre, song, title, etc., across one or more user characteristics selected from one or more device type and/or one or more demographic segment(s) (e.g., one or more age group(s), one or more gender(s), and/or any other user characteristic(s)).

In some examples, the media exposure metrics are used to determine demographic reach of streaming media, ratings for streaming media, engagement indices for streaming media, user affinities associated with streaming media, broadcast media, and/or any other audience measure metric associated with streaming media, and/or one or more aspects and/or components of streaming media (e.g., an actor's name). In some examples, the media exposure metrics are audience share metrics indicative of percentages of audiences for different device types that accessed the same media. For example, the metrics may indicate a first percentage of an audience may be exposed to news media via smart phones, while a second percentage of the audience may be exposed to the same news media via tablets.

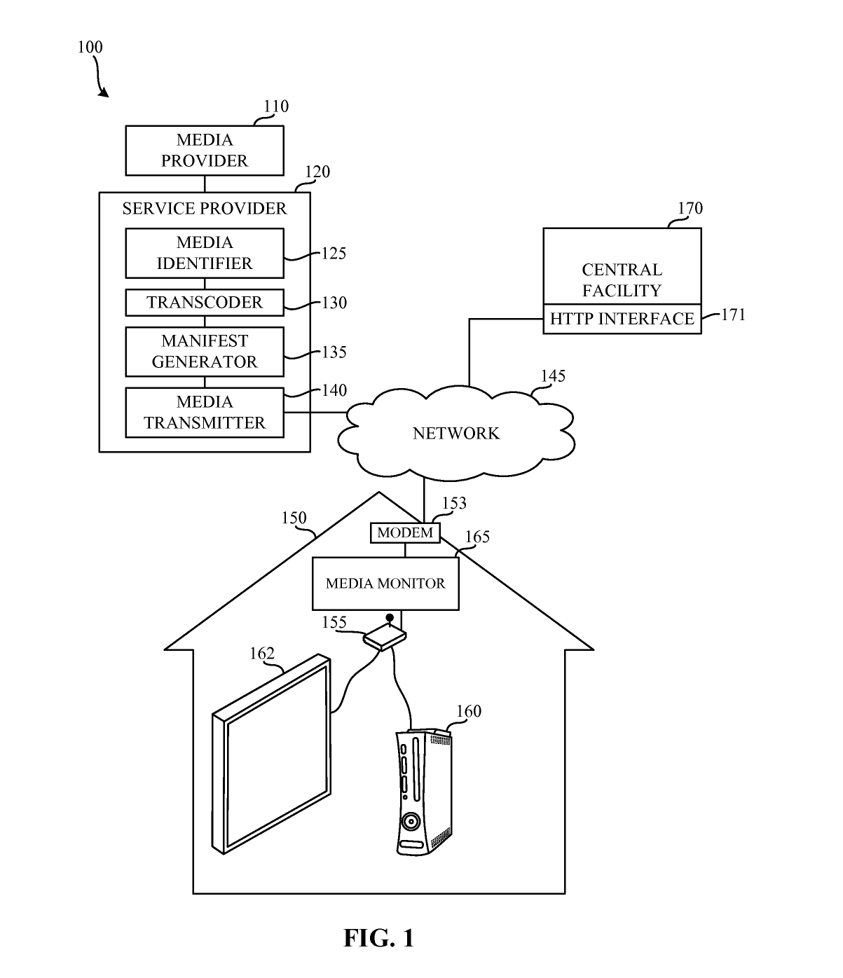

FIG. 1 is a block diagram of an example system 100 constructed in accordance with the teachings of this disclosure for measuring exposure to streaming media. The example system 100 of FIG. 1 monitors media provided by an example media provider 110 for presentation on an example media device 160, 162 via an example network 145. FIG. 1 includes an example service provider 120, an example media exposure measurement location 140, and an example central facility 170 of an audience measurement entity. While the illustrated example of FIG. 1 discloses an example implementation of the service provider 120, other example implementations of the service provider 120 may additionally or alternatively be used, such as the example implementations disclosed in U.S. patent application Ser. No. 13/341,646, which is hereby incorporated by reference herein in its entirety.

The media provider 110 of the illustrated example of FIG. 1 corresponds to any one or more media provider(s) capable of providing media for presentation via the media device 160, 162. The media provided by the media provider(s) 110 can provide any type(s) of media, such as audio, video, multimedia, etc. Additionally, the media can correspond to live media, streaming media, broadcast media, stored media, on-demand content, etc.

The service provider 120 of the illustrated example of FIG. 1 provides media services to the media device 160, 162 via, for example, web pages including links (e.g., hyperlinks, embedded media, etc.) to media provided by the media provider 110. In the illustrated example, the service provider 120 modifies the media provided by the media provider 110 prior to transmitting the media to the media device 160, 162. In the illustrated example, the service provider 120 includes an example media identifier 125, an example transcoder 130, an example manifest generator 135, and an example media transmitter 140. While the illustrated example of FIG. 1 discloses an example implementation of the service provider 120, other example implementations of the service provider 120 may additionally or alternatively be used, such as the example implementations disclosed in U.S. patent application Ser. No. 13/445,961, which is hereby incorporated by reference herein in its entirety.

The media identifier 125 of the illustrated example of FIG. 1 is implemented by a logic circuit such as a processor executing instructions, but it could additionally or alternatively be implemented by an application specific integrated circuit(s) (ASIC(s)), programmable logic device(s) (PLD(s)), field programmable logic device(s) (FPLD(s)), an analog circuit, and/or digital circuitry. The media identifier 125 of FIG. 1 extracts metering data (e.g., signatures, watermarks, etc.) from the media obtained from the media provider 110. For example, the media identifier 125 can implement functionality provided by a software development kit (SDK) to extract one or more audio watermarks, one or more video (e.g., image) watermarks, etc., embedded in the audio and/or video of the media obtained from the media provider 110. (For example, the media may include pulse code modulation (PCM) audio data or other types of audio data, uncompressed video/image data, etc.)

The example media identifier 125 of FIG. 1 determines (e.g., derives, decodes, converts, etc.) the metering data (e.g., such as media identifying information, source identifying information, etc.) included in or identified by a watermark embedded in, associated with, and/or transmitted with the media, and converts this metering data into a text and/or binary format for inclusion in an ID3 tag and/or other data type (e.g., text, binary, etc.) for insertion as metadata in a fragment identifier associated with the streaming media. In other examples, the code/watermark itself is extracted and inserted as metadata in a text or binary format in the fragment identifier. As disclosed herein, the metadata and/or media-identifying metadata inserted within the fragment identifier may be a text or binary representation of a code, a watermark, and/or metadata or data identified by a code and/or watermark, etc.

The example transcoder 130 of the illustrated example of FIG. 1 is implemented by a logic circuit such as a processor executing instructions, but could additionally or alternatively be implemented by any other logic circuit, ASIC, DSP, FPGA, and/or other analog and/or digital circuitry. In some examples, the transcoder 130 and the media identifier 125 are implemented by the same physical processor. In the illustrated example, the transcoder 130 employs any appropriate technique(s) to transcode and/or otherwise process the received media into a form suitable for streaming (e.g., a streaming format). For example, the transcoder 130 of the illustrated example transcodes the media in accordance with MPEG2 audio/video compression for use via the HLS protocol.

The manifest generator 135 of the illustrated example of FIG. 1 is implemented by a logic circuit such as a processor executing instructions, but could additionally and/or alternatively be implemented by any other logic circuit, ASIC, DSP, FPGA, and/or other analog and/or digital circuitry. In some examples, the transcoder 130, the media identifier 125, and the manifest generator 135 are implemented by the same physical processor.

In the illustrated example, the manifest generator 135 embeds the code/watermark and/or metadata representative of the code/watermark into a manifest file used in association with the streaming media. In some examples the metadata is embedded as a fragment identifier within a URL of a corresponding segment of the streaming media. In the illustrated example, the manifest 205 is an .m3u file that describes the available transport streams to the client device. However, any other past, present, and/or future file format may additionally or alternatively be used such as, for example, an .m3u8 file format. In some examples, the manifest generator 135 inserts ID3 tag metadata corresponding to the code and/or the metering metadata into the manifest (i.e., within the fragment identifier(s)) to identify particular events occurring within a respective media segment such as, for example, when an advertisement is displayed via product placement, when a dedicated advertisement is displayed, when a particular event occurs within the media (e.g., when a contestant on a television game show answers a question, when a streamed movie returns from an advertisement, etc.), etc.

The media transmitter 140 of the illustrated example of FIG. 1 is implemented by a logic circuit such as a processor executing instructions, but could additionally or alternatively be implemented by any other circuit, ASIC, DSP, FPGA, and/or other analog and/or digital circuitry. In some examples, the transcoder 130, the media identifier 125, the manifest generator 135, and the media transmitter 140 are implemented by the same physical processor.

The media transmitter 140 employs any appropriate technique(s) to select and/or stream the media to a requesting device, such as the media device 160. For example, the media transmitter 140 of the illustrated example selects media that has been identified by the media identifier 125, transcoded by the transcoder 130 and had the identified media-identifying metadata and/or code/watermark embedded in a manifest by the manifest generator 135. The media transmitter 140 then streams the media to the media device 160, 162 via the network 145 using HLS or any other streaming protocol such as, for example, Media Player version 4 (MP4), Adobe Flash (FLV), Moving Picture Experts Group (MPEG) version 2 (MPEG2, MPEG version 4 (MPEG4), etc.

In some examples, the media identifier 125, the transcoder 130, and/or the manifest generator 135 prepare media for streaming regardless of whether (e.g., prior to) a request is received from the media device 160, 162. In such examples, the already-prepared media is stored in a data store of the service provider 120 (e.g., such as in a flash memory, magnetic media, optical media, etc.). In such examples, the media transmitter 140 prepares a transport stream for streaming the already-prepared media to the media device 160, 162 when a request is received from the media device 160, 162. In other examples, the media identifier 125, the transcoder 130, and/or the manifest generator 135 prepare the media for streaming in response to a request received from the media device 160, 162.

The network 145 of the illustrated example is the Internet. Additionally or alternatively, any other network(s) communicatively linking the service provider 120 and the media device 160, 162 such as, for example, a private network, a local area network (LAN), a virtual private network (VPN), etc. may be used. The network 145 may comprise any number of public and/or private networks using any type(s) of networking protocol(s).

In the illustrated example, the media exposure measurement location 140 includes media devices 160, 162. The media exposure measurement location 140 of the illustrated example of FIG. 1 is a panelist household. However, the media exposure measurement location 140 may be any other location, such as, for example an internet café, an office, an airport, a library, a non-panelist household, etc. While in the illustrated example a single media exposure measurement location 140 is shown, any number and/or type(s) of media exposure measurement locations may be used.

The media devices 160, 162 of FIG. 1 are devices that retrieve media from the service provider 120 for presentation at the media exposure measurement location 140. In some examples, the media devices 160, 162 are capable of directly presenting media (e.g., via a display) while, in some other examples, the media devices 160, 162 present the media on separate media presentation equipment (e.g., speakers, a display, etc.). The media device 162 of the illustrated example is an Internet enabled television, and thus, is capable of directly presenting media (e.g., via an integrated display and speakers). The media device 160 of the illustrated example is a gaming console (e.g., Xbox®, Playstation® 3, etc.) and requires additional media presentation equipment (e.g., a television) to present media. While, in the illustrated example, an Internet enabled television, and a gaming console are shown, any other type(s) and/or number(s) of media device(s) may additionally or alternatively be used. For example, Internet-enabled mobile handsets (e.g., a smartphone), tablet computers (e.g., an iPad®,) digital media players (e.g., a Roku® media player, a Slingbox®, etc.,) etc. may additionally or alternatively be used. Further, while in the illustrated example two media devices are shown, any number of media devices may be used.

The modem 153 of the illustrated example of FIG. 1 is a modem that enables network communications of the media exposure measurement location 140 to reach the network 145. In some examples, the modem 153 is a digital subscriber line (DSL) modem, while in some other examples the modem 153 is a cable modem. In some examples, the modem 153 is a media converter that converts one type of communications format (e.g., electrical communications, optical communications, wireless communications, etc.) into another type of communications format. In the illustrated example, the modem 153 is separate from the network gateway 155. However, in some examples, the modem 153 is a part of (e.g., integral to) the network gateway 155.

The example network gateway 155 of the illustrated example of FIG. 1 is a router that enables the media devices 160, 162 to communicate with the network 145 (e.g., the Internet.) In some examples, the example network gateway 155 includes gateway functionality such as modem capabilities. In some other examples, the example network gateway 155 is implemented in two or more devices (e.g., a router, a modem, a switch, a firewall, etc.).

In some examples, the example network gateway 155 hosts a Local Area Network (LAN) for the media exposure measurement location 140. In the illustrated example, the LAN is a wireless local area network (WLAN), and allows the media devices 160, 162 to wirelessly transmit and receive data via the Internet. Alternatively, the network gateway 155 may be wired to such a LAN.

The media monitor 165 of the illustrated example of FIG. 1 is a network device interposed between the LAN hosted by the example network gateway 155 and the network 145. Additionally or alternatively, the media monitor 165 may be a device on the LAN. The media monitor 165 of the illustrated example identifies network communications from the media devices 160, 162 within the media exposure measurement location 140 that include media-identifying metadata as part of a fragment identifier. The example media monitor 165 of FIG. 1 creates a record (e.g., a log) identifying which of the media device(s) 160, 162 were involved in which of the network communications and transmits the record to the central facility 170 at any desired rate (e.g., continuously, periodically, aperiodically, etc.). In some examples, the media monitor 165 determines which device was involved in the network communications based on an address of the media device (e.g., an IP address, a MAC address, etc.).

In some examples, the example network gateway 155 permits custom firmware and/or software to be loaded and/or executed. In some such examples, the network gateway 155 may be provided with firmware and/or software that, in addition to standard routing and/or modem behavior, monitors messages or data packets directed from the media devices 160, 162 to the network 145 and/or directed from the network 145 to the media devices 160, 162. Additionally or alternatively, such monitoring functionality may be part of a separate device such as, for example, the media monitor 165, the media device 160, 162, etc.

The central facility 170 of the illustrated example is a facility of an audience measurement entity (e.g., the Nielsen Company (US) LLC) and includes an interface to receive reported metering information (e.g., metadata) from the media monitor 165 via the network 145. In the illustrated example, the central facility 170 includes an HTTP interface 171 to receive HTTP requests that include the metering information. The HTTP requests are sent with the metering information in their payload. The requests may not be intended to actually retrieve media (e.g., content), but are instead used as a vehicle to convey the metering information. Thus, the requests may be referred to as dummy requests in that they are not actually intended to retrieve any media. The central facility 170 is provided with software (e.g., a daemon) to extract the metering information from the payload of the dummy request(s). Additionally or alternatively, any other method(s) to transfer the metering information may be used such as, for example, an HTTP Secure protocol (HTTPS), a file transfer protocol (FTP), a secure file transfer protocol (SFTP), an HTTP and/or HTTPS GET request, an HTTP and/or HTTPS POST request, etc. In the illustrated example, the central facility 170 stores and analyzes the extracted metering information received from a plurality of different media devices. For example, the central facility 170 may sort and/or group metadata by media provider 110 (e.g., by grouping all metadata associated with a particular media provider 110). Any other processing of metering information may additionally or alternatively be performed. In some examples, the central facility 170 adds a timestamp to the metadata upon receipt. Timestamping (e.g., recording a time that an event occurred) enables accurate identification and/or correlation of media that was presented and/or the time that it was presented with the user(s) of the presentation device. Such timestamping may additionally or alternatively be performed by the media monitor 165.

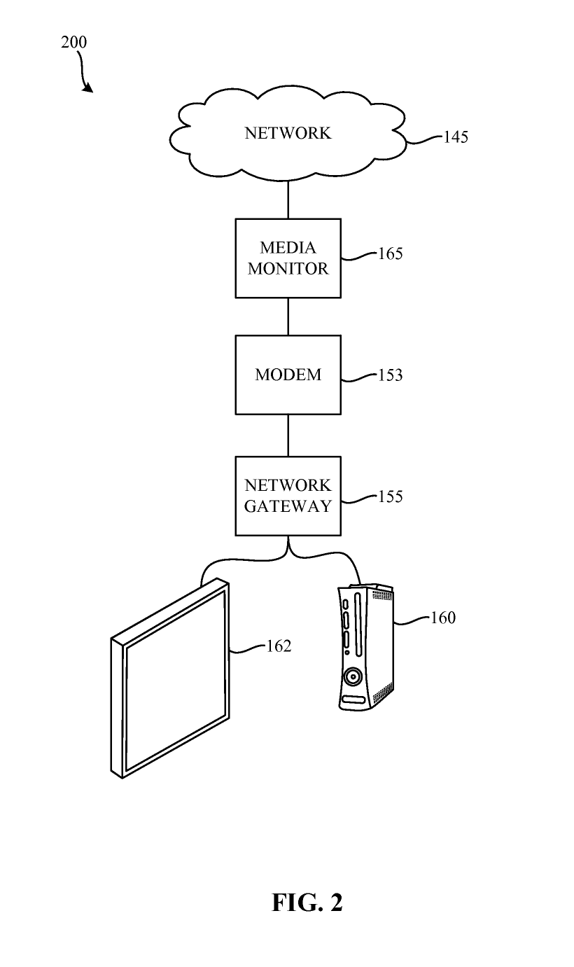

FIG. 2 is a block diagram of an example configuration 200 of the network devices shown in FIG. 1. In the example configuration 200 of FIG. 2, the media monitor 165 is placed between the network 145 and the modem 153. The modem 153 communicates with the network gateway 155, which in turn communicates with the media devices 160, 162. In the illustrated example, the media monitor 165 monitors communications between the modem 153 and the network 145. For example, when the modem 153 is a DSL modem the media monitor 165 monitors the DSL communications. In the illustrated example, the media monitor 165 includes one or more ports (e.g., a DSL port, a cable port, etc.) for receiving and/or transmitting network communications.

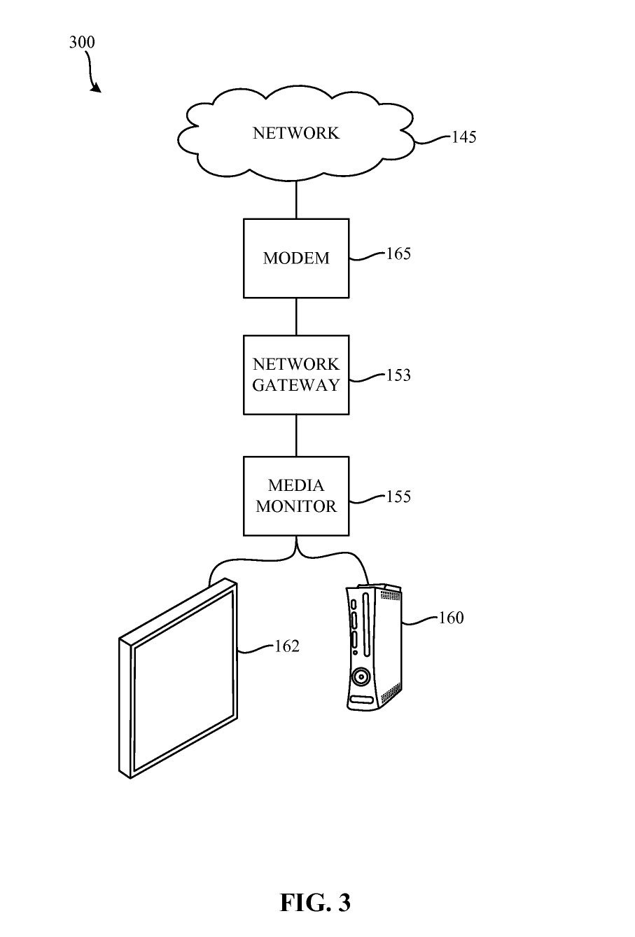

FIG. 3 is a block diagram of another example configuration 300 of the network devices shown in FIG. 1. In the example configuration 300 of FIG. 3, the media monitor 165 is placed between the network gateway 155 and the media devices 160, 162. Thus, the modem 153 communicates with the network gateway 155. The network gateway 155 communicates with the media devices 160, 162, and those communications pass through the media monitor 165. In the illustrated example of FIG. 3, the media monitor 165 monitors communications between the network gateway 155 and the media devices 160, 162. In some examples, the media monitor 165 is a network routing device (e.g., a router, a switch, a hub, etc.) that monitors network communications. In the illustrated example, because the modem 153 and the network gateway 155 are adjacent, they may be combined into a single device. For example, a combined gateway and modem device may additionally or alternatively be used.

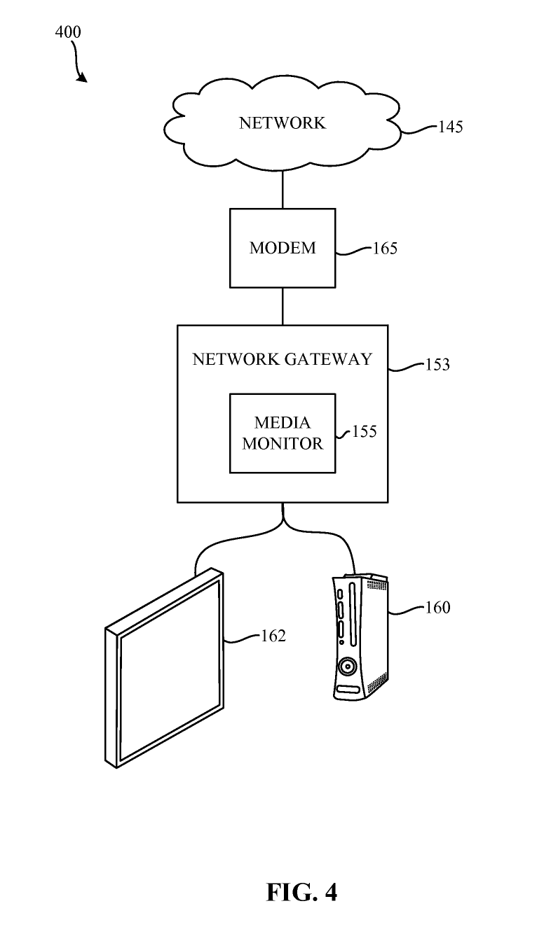

FIG. 4 is a block diagram of an example configuration 400 of the network devices shown in FIG. 1. In the example configuration 400 of the illustrated example, the media monitor 165 is implemented inside the network gateway 155. That is, the example network gateway 155 of FIG. 4 permits custom firmware and/or software to be loaded and/or executed. In the illustrated example of FIG. 4, the network gateway 155 is provided with firmware and/or software that, in addition to standard routing and/or modem behavior, monitors messages or data packets directed from the media devices 160, 162 to the network 145 and/or directed from the network 145 to the media devices 160, 162.

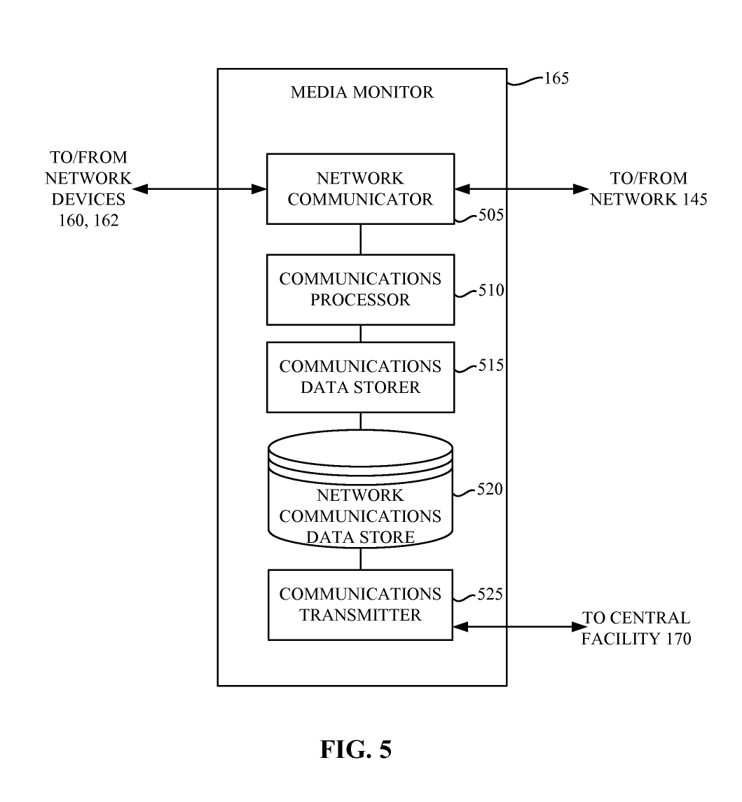

FIG. 5 is a block diagram of an example implementation of the example media monitor 165 of FIG. 1. The example media monitor 165 of FIG. 5 includes a network communicator 505, a communications processor 510, a communications data storer 515, a communications data store 520, and a communications transmitter 525.

The network communicator 505 of the illustrated example of FIG. 5 is an Ethernet interface. In the illustrated example, the network communicator 510 receives network communications (e.g., HTTP requests, etc.) from the network gateway 155, the media devices 160, 162, and/or the modem 153. The network communicator 505 transmits the network communications to the network 145, and receives and/or transmits network communications in the reverse path (e.g., towards the LAN). While in the illustrated example, the network communicator 505 is an Ethernet interface, any other type of interface may additionally or alternatively be used. For example, the network communicator 505 might include one or more of a Bluetooth interface, a WiFi interface, a digital subscriber line (DSL) interface, a T1 interface, etc. While in the illustrated example a single network communicator 505 is shown, any number and/or type(s) of network communicators may additionally or alternatively be used. For example, two network communicators (e.g., Ethernet interfaces) may be used. In such an example, a first network communicator may receive and/or transmit network communications to and/or from the network gateway 155 while a second network communicator may receive and/or transmit network communications to and/or from the network 155.

The communications processor 510 of the illustrated example of FIG. 5 intercepts and inspects network communications received by the network communicator 505. The example communications processor 510 of FIG. 5 is implemented by a logic circuit such as a processor executing instructions, but could additionally or alternatively be implemented by any other logic circuit, ASIC, DSP, FPGA, and/or other analog and/or digital circuitry. In the illustrated example, the communications processor 510 examines network communications intercepted by the network communicator 505 to identify network communications containing a fragment identifier including media-identifying metadata (e.g., a code, a watermark, a media-identifying text string, a media originator name, etc.). In some examples, the communications processor 510 identifies the media device 160, 162 involved in the network communications.

The communications data storer 515 of the illustrated example of FIG. 5 stores network communications identified by the communications processor 510 in the network communications data store 520. The example data storer 515 of the illustrated example is implemented by a logic circuit such as a processor executing instructions, but could additionally or alternatively be implemented by any other logic circuit, ASIC, DSP, FPGA, and/or other analog and/or digital circuitry. The communications processor 510 and the data storer 515 may be implemented by the same physical processor. In the illustrated example, network communications identified by the communications processor 510 are stored in association with the media device(s) 160, 162 identified as receiving and/or transmitting a network communications. In the illustrated example, such an association is made based on an address of the media device 160, 162 (e.g., an IP address, a MAC address, etc.).

The network communications data store 520 of the illustrated example of FIG. 5 may be any device for storing data such as, for example, flash memory, magnetic media, optical media, etc. Furthermore, the data stored in the network communications data store 520 may be in any data format such as, for example, binary data, comma delimited data, tab delimited data, structured query language (SQL) structures, etc. While, in the illustrated example, the network communications data store 520 is illustrated as a single database, the network communications data store 520 may be implemented by any number and/or type(s) of databases.

The communications transmitter 525 of the illustrated example of FIG. 5 transmits network communications data stored in the network communications data store 520. In the illustrated example, the communications transmitter 525 is implemented by a processor executing instructions, but it could alternatively be implemented by an ASIC, DSP, FPGA, or other circuitry. The communications transmitter 525 may be implemented on the same physical processor as the communications processor 510 and/or the communications data storer 515. The communications transmitter 525 of the illustrated example periodically and/or a-periodically transmits network communications data from the network communications data store 520 to the central facility 170.

The example communications transmitter 525 may transmit the network communications data upon determining that the amount of network communications data stored in the network communication data store 520 has reached a threshold, and/or in response to a clock (e.g., a time limit specifying that network communications are transmitted once every day). Transmitting network communications every day ensures that there is little lag time between the occurrence of the network communications and the ability to analyze the network communications. However, the transmission may occur at any desired interval(s) such as, for example, transmitting once every hour, once every week, etc. In examples in which the transmission is triggered based on an amount of network communications data stored in the network communications data store 520, the transmission threshold might indicate that network communications should be transmitted if there is more than a predetermined amount (e.g., one megabyte) of network communications data stored in the network communications data store 520. Any data storage amount may be used for such a trigger such as, for example, ten megabytes, one hundred megabytes, etc. Additionally or alternatively, multiple transmission thresholds may be present. For example, a threshold indicating that network communications data should be transmitted at least once a day and a threshold indicating that network communications data should be transmitted if more than one megabyte of network communications data is stored in the network communications data store 520 might be used.

In the illustrated example, the communications transmitter 525 transmits the network communications data via the network 145. However, the communications transmitter 525 may transmit network communications data in any other fashion. For example, the media monitor 165 and/or a memory of the media monitor 165 (e.g., the network communications data store 520) may be physically mailed to the network central facility 170 and/or the communications transmitter 525 might transmit network communications data via, for example, a USB connection, a Bluetooth connection, a serial connection, a local area network (LAN), etc.

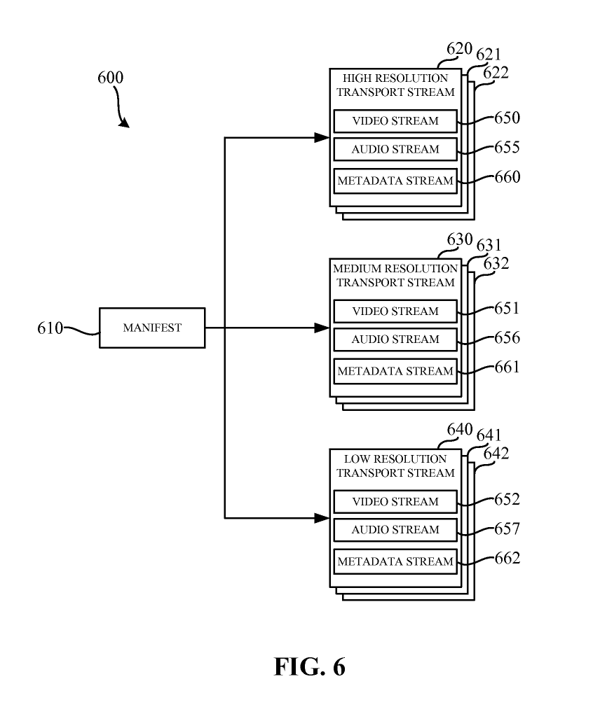

FIG. 6 is a block diagram of an example implementation of an example HLS stream 600 that may be delivered to the example media device(s) 160, 162 of FIG. 1. In the illustrated example of FIG. 6, the HLS stream 600 includes a manifest 610 and three transport streams. The example manifest 610 is a playlist that defines addresses of files to be retrieved and/or presented by the media device 160, 162. In the illustrated example, the manifest 610 is an .m3u file that describes the available transport streams to the client device. However, any other past, present, and/or future file format may additionally or alternatively be used such as, for example, an .m3u8 file format. In the illustrated example, the media device 160 retrieves the manifest 610 in response to an instruction to display an HLS element.

HLS is an adaptive format, in that, although multiple devices retrieve the same manifest 610, different transport streams may be displayed depending on one or more factors. For example, devices having different bandwidth availabilities (e.g., a high speed Internet connection, a low speed Internet connection, etc.) and/or different display abilities (e.g., a small size screen such as a cellular phone, a medium size screen such as a tablet and/or a laptop computer, a large size screen such as a television, etc.) select an appropriate transport stream for their display and/or bandwidth abilities. In some examples, a cellular phone having a small screen and limited bandwidth uses a low-resolution transport stream. Alternatively, in some examples, a television having a large screen and a high speed Internet connection uses a high-resolution transport stream. As the abilities of the device change (e.g., the device moves from a high-speed Internet connection to a low speed Internet connection) the device may switch to a different transport stream.

In the illustrated example of FIG. 6, a high-resolution transport stream 620, a medium resolution transport stream 630, and a low-resolution transport stream 640 are shown. In the illustrated example, each transport stream 620, 630, and/or 640 represents a portion of the associated media (e.g., five seconds, ten seconds, thirty seconds, one minute, etc.). Accordingly, the high resolution transport stream 620 corresponds to a first portion of the media, a second high resolution transport stream 621 corresponds to a second portion of the media sequential to the first portion of the media, a third high resolution transport stream 622 corresponds to a third portion of the media sequential to the second portion of the media. Likewise, the medium resolution transport stream 630 corresponds to the first portion of the media, a second medium resolution transport stream 631 corresponds to the second portion of the media, and a third medium resolution transport stream 632 corresponds to the third portion of the media. In addition, the low resolution transport stream 640 corresponds to the first portion of the media, a second low resolution transport stream 641 corresponds to the second portion of the media, and a third low resolution transport stream 642 corresponds to the third portion of the media. Although three transport streams are shown in the illustrated example of FIG. 6 for each resolution, any number of transport streams representing any number of corresponding portions of the media may additionally or alternatively be used.

In the illustrated example, each transport stream 620, 621, 622, 630, 631, 632, 640, 641, and/or 642 includes a video stream 650, 651, 652, an audio stream 655, 656, 652, and a metadata stream 660, 661, 662. The video stream 650, 651, and/or 652 includes video associated with the media at different resolutions according to the resolution of the transport stream with which the video stream is associated. The audio stream 655, 656, and/or 654 includes audio associated with the media. The metadata stream 660, 661, and/or 662 may include metadata such as, for example, an ID3 tag associated with the media.

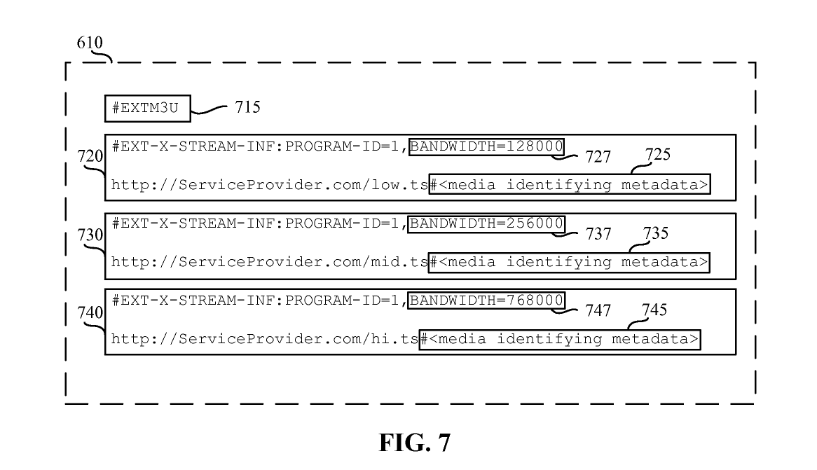

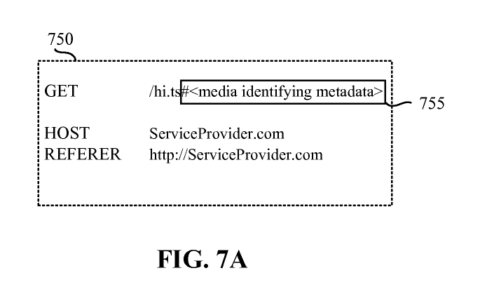

FIG. 7 illustrates an example manifest 205 describing the example HLS stream of FIG. 6. The example manifest 610 of FIG. 7 may be generated by the manifest generator 135 of the service provider 120 for use by the example media device 160, 162 of FIG. 1. The example manifest 610 of FIG. 7 includes a format identifier 715. In the illustrated example, the format identifier identifies the format of the manifest 610 as an m3u format. However, any other format may additionally or alternatively be used.

In the illustrated example, the manifest 610 includes a first media address identification segment 720, a second media address identification segment 730, and a third media address identification segment 740. The first media address identification segment 720 includes a first fragment identifier 725. The second media address identification segment 730 includes a second fragment identifier 735. The third media address identification segment 740 includes a third fragment identifier 745.

In the illustrated example, the first media address identification segment 720 identifies a low bandwidth media stream. For example, the first media address identification segment 720 includes a first bandwidth identifier 727. The first bandwidth identifier 727 indicates that the first media address identification segment 720 is to be used when the bandwidth available to the media device 160, 162 is one hundred and twenty eight kilobits per second (e.g., 128 kbps) or less. When such a bandwidth condition is met, the media device 160, 162 requests media via a first address of the first media address identification segment 720. The first address includes the first fragment identifier 725. When the request is sent by the media device 160, 162, the request includes the first fragment identifier 725, thereby enabling the media monitor 165 to identify the media via the media-identifying metadata included in the first fragment identifier 725.

In the illustrated example, the second media address identification segment 730 identifies a medium bandwidth media stream. For example, the second media address identification segment 730 includes a second bandwidth identifier 737 indicating that the second media address identification segment 730 is to be used when the bandwidth available to the media device 160, 162 is approximately two hundred and fifty six kilobits per second (e.g., 256 kbps). When such a bandwidth condition is met, the media device 160, 162 requests media via a second address of the second media address identification segment 730. The second address includes the second fragment identifier 735. When the request is sent by the media device 160, 162, the request includes the second fragment identifier 735, thereby enabling the media monitor 165 to identify the media via the media-identifying metadata included in the second fragment identifier 735.

In the illustrated example, the third media address identification segment 740 identifies a high bandwidth media stream. For example, the third media address identification segment 740 includes a third bandwidth identifier 747 indicating that the third media address identification segment 740 is to be used when the bandwidth available to the media device 160, 162 is approximately seven hundred and sixty eight kilobits per second (e.g., 768 kbps). When such a bandwidth condition is met, the media device 160, 162 requests media via a third address of the third media address identification segment 740. The third address includes the third fragment identifier 745. When the request is sent by the media device 160, 162, the request includes the third fragment identifier 745, thereby enabling the media monitor 165 to identify the media via the media-identifying metadata included in the third fragment identifier 745.

While in the illustrated example three media address identification segments associated with different bandwidth levels are used, any other number and/or type(s) of media address identification segments may additionally or alternatively be used. For example, media address identification segments having different bandwidth values may be used. Furthermore, other qualifiers such as, for example, different codecs supported by the media device 160, 162, whether encryption is supported, etc. may additionally or alternatively be used. In the illustrated example, a single address is included with each media address identification segment 720, 730, 740. However, in some examples, multiple addresses may be included with each media address identification segment. In such an example, the multiple addresses may correspond to successive media segments to be played within each media address identification segment.

In the illustrated example, the first, second, and third fragment identifiers 725, 735, 745 are identical. That is, they are the same in that they include media-identifying metadata identifying the same media. However, in some examples, the fragment identifiers may uniquely identify the respective media segments. Such a distinction may be useful for determining how panelists watch different types of media. For example, individually identified media segments (via unique fragment identifiers) may enable distinguishing whether viewers are more likely to view sporting events only when high bandwidth is available versus accepting low bandwidth conditions when viewing a news report.

The media address identification segments 720, 730, 740 identify addresses of media to be presented by the example media device 160, 162. In the illustrated example, the addresses indicate that the media should be retrieved using HTTP. However, any other communication standard may additionally or alternatively be used such as, for example, FTP, HTTPS, etc. In the illustrated example, the addresses indicate that the media segments are to be retrieved from the service provider. However, the media segments identified by the addresses may additionally or alternatively be retrieved from any other location and/or address such as, for example, an advertisement provider, a third party, etc.

FIG. 7A illustrates an example HTTP request 750 that may be transmitted by the example media devices 160, 162 of FIG. 1. The example HTTP request 750 of FIG. 7A corresponds to the third media address identification segment 740 of FIG. 7, in that the high bandwidth media stream is being requested. In the illustrated example of FIG. 7A, the HTTP request 750 is formatted as an HTTP GET request. However, any other type and/or format of request may additionally or alternatively be used. In the illustrated example, a fragment identifier 755 is included. The fragment identifier 755 is identified based on the presence of a hash “#” in the name of the requested resource. The example fragment identifier 755 is included in the request portion of the HTTP request 750 of FIG. 7A. However, the fragment identifier 755 may additionally or alternatively be included in any other portion of the HTTP request 750 such as, for example, a hostname, a referrer, etc.

While an example manner of implementing service provider 120 of FIG. 1, the example media monitor 165 of FIGS. 1 and/or 5, the example media device 160, 162 of FIG. 1, and/or the example central facility 170 of FIG. 1 is illustrated in FIGS. 1 and/or 5, one or more of the elements, processes and/or devices illustrated in FIGS. 1 and/or 5 may be combined, divided, re-arranged, omitted, eliminated and/or implemented in any other way. Further, the example media identifier 125, the example transcoder 130, the example manifest generator 135, the example media transmitter 140, and/or more generally, the example service provider 120 of FIG. 1, the example network communicator 505, the example communications processor 510, the example communications data storer 515, the example network communications data store 520, the example communications transmitter 525, and/or more generally, the example media monitor 165 of FIGS. 1 and/or 5, the example media device 160, 162 of FIG. 1, and/or the example HTTP interface 171, and/or, more generally, the example central facility 170 of FIG. 1 may be implemented by hardware, software, firmware and/or any combination of hardware, software and/or firmware. Thus, for example, any of the example media identifier 125, the example transcoder 130, the example manifest generator 135, the example media transmitter 140, and/or more generally, the example service provider 120 of FIG. 1, the example network communicator 505, the example communications processor 510, the example communications data storer 515, the example network communications data store 520, the example communications transmitter 525, and/or more generally, the example media monitor 165 of FIGS. 1 and/or 5, the example media device 160, 162 of FIG. 1, and/or the example HTTP interface 171, and/or, more generally, the example central facility 170 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example media identifier 125, the example transcoder 130, the example manifest generator 135, the example media transmitter 140, the example network communicator 505, the example communications processor 510, the example communications data storer 515, the example network communications data store 520, the example communications transmitter 525, the example media device 160, 162 of FIG. 1, the example HTTP interface 171, and/or the example central facility 170 of FIG. 1 are hereby expressly defined to include a tangible computer readable storage device or storage disc such as a memory, DVD, CD, Blu-ray, etc. storing the software and/or firmware. Further still, the example service provider 120 of FIG. 1, the example media monitor 165 of FIGS. 1 and/or 5, the example media device 160, 162 of FIG. 1, and/or the example central facility 170 of FIG. 1 may include one or more elements, processes and/or devices in addition to, or instead of, those illustrated in FIGS. 1 and/or 5, and/or may include more than one of any or all of the illustrated elements, processes and devices.

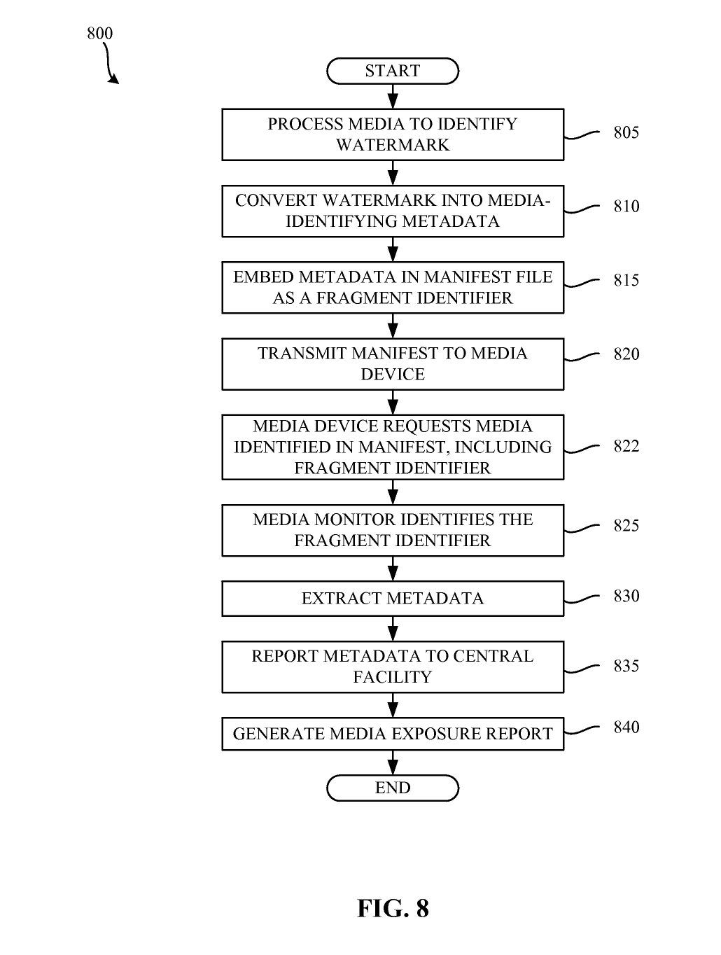

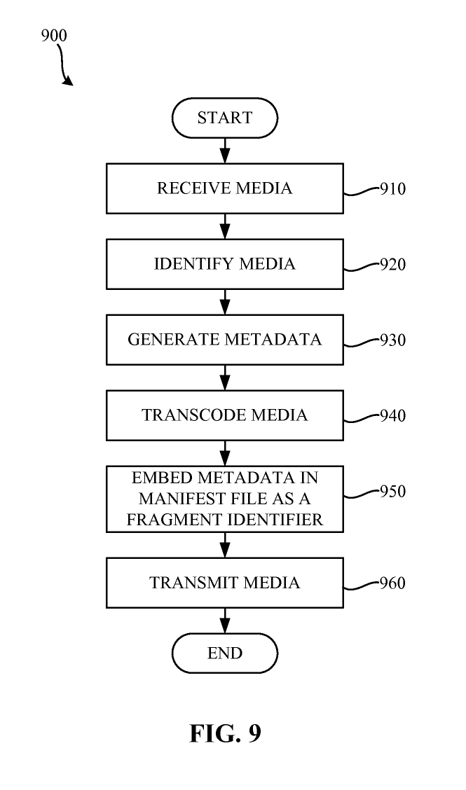

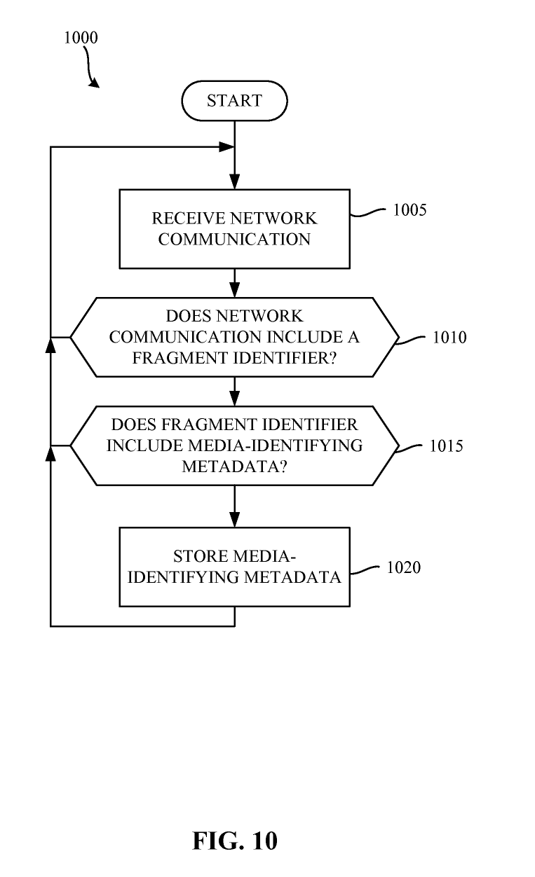

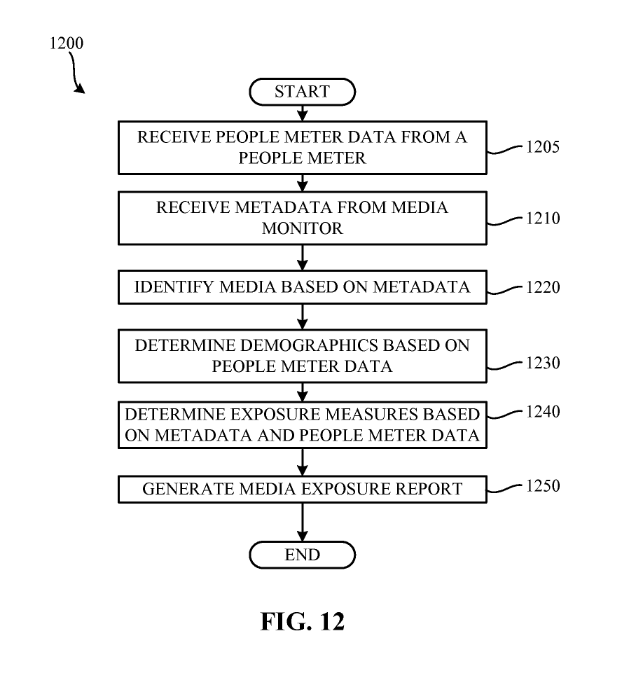

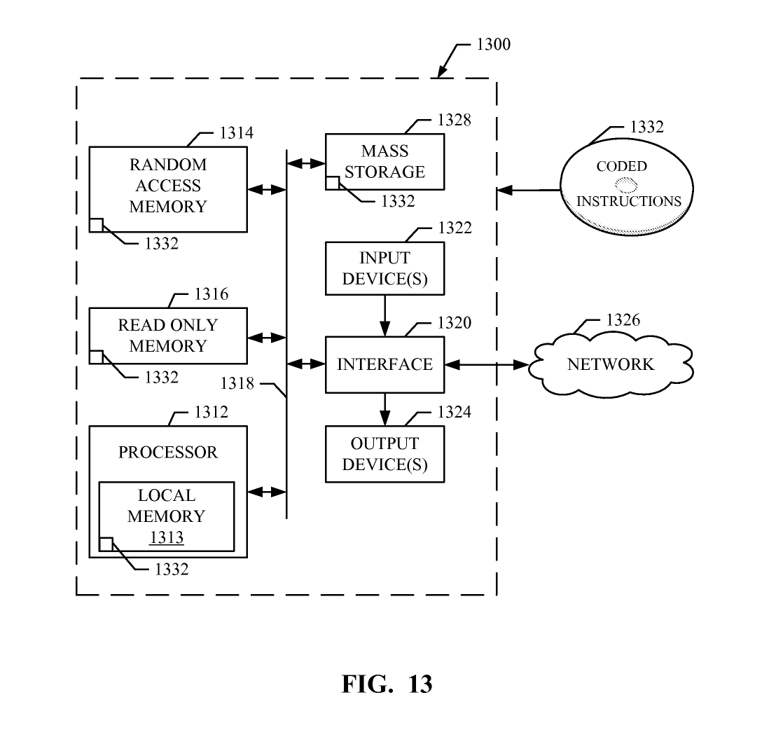

A flowchart representative of example machine readable instructions for implementing the example service provider 120, the example media monitor 165, the example media device 160, 162 of FIG. 1, and/or the example central facility 170 is shown in FIG. 8. A flowchart representative of example machine readable instructions for implementing the example service provider 120 is shown in FIG. 9. Flowcharts representative of example machine readable instructions for implementing the example media monitor 165 are shown in FIGS. 10 and/or 11. A flowchart representative of example machine readable instructions for implementing the example central facility 170 is shown in FIG. 12. In these examples, the machine readable instructions comprise a program for execution by a processor such as the processor 1312 shown in the example processor platform 1300 discussed below in connection with FIG. 13. The program may be embodied in software stored on a tangible computer readable storage medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 8, 9, 10, 11, and/or 12, many other methods of implementing the example service provider 120, the example media monitor 165, the example media device 160, 162 of FIG. 1, and/or the example central facility 170 may alternatively be used. For example, the order of execution of the blocks may be changed, and/or some of the blocks described may be changed, eliminated, or combined.

As mentioned above, the example processes of FIGS. 8, 9, 10, 11, and/or 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 8, 9, 10, 11, and/or 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 8 is a flowchart representative of example machine-readable instructions which may be executed to implement the example service provider 120 of FIG. 1, the example media device(s) 160, 162 of FIG. 1, the example media monitor 165 of FIG. 1, and/or the example central facility 170 of FIG. 1. The example process 800 of FIG. 8 begins when the media identifier 125 of the service provider 120 processes media to be transmitted to the media device 160, 162 to identify a watermark (block 805). In the illustrated example of FIG. 8, a watermark (e.g., a watermark used by, for example, the Nielsen Company (US) LLC) that was previously embedded into the media is used to identify the media. However, any other way of identifying media may additionally or alternatively be used such as, for example, codes, signatures, fingerprints, etc. The example media identifier 125 service provider 120 of FIG. 1 generates media identifying metadata based on the watermark (block 810). The media identifying metadata is embedded into a manifest file as a fragment identifier (block 815) by the manifest generator 135 of the service provider 120.

The manifest (including the media-identifying metadata) is transmitted to the media device 160, 162 (block 820) by the media transmitter 140. In the illustrated example, the manifest causes the media device 160, 162 to transmit a request for the media identified in the manifest (block 822). Because the address of the media identified in the manifest includes the fragment identifier, the request includes the fragment identifier and, accordingly, the media-identifying metadata.

Once the media device 160, 162 makes a request for the media, the request passes through the media monitor 165. The communications processor 510 of the media monitor identifies the fragment identifier included in the request (block 825). The communications processor 510 extracts the metadata included in the fragment identifier (block 830). The extracted metadata is reported by the communications transmitter 525 of the media monitor 165 to the central facility 170 (block 835). With the metadata received at the central facility 170, central facility 170 generates a media exposure report summarizing the media exposure metrics (block 840). In the illustrated example, the media exposure report identifies viewing preferences of viewers having different demographic details. However, the media exposure report may identify any other metrics and/or statistics associated with media exposure.

FIG. 9 is a flowchart representative of example machine-readable instructions 900 which may be executed to implement the example service provider 120 of FIG. 1. Execution of the example machine-readable instructions 900 of FIG. 9 begins with the media identifier 125 of the service provider 120 receiving the media from the media provider 110 (block 910). In the illustrated example, the media is received as it is broadcast. However, in some examples, the media is stored and/or cached by the media identifier 125.

The media identifier 125 of the illustrated example then identifies the media (block 920). The media identifier 125 identifies the media by extracting metering data (e.g., signatures, watermarks, codes, etc.) from the media. Based on the extracted metering data, the media identifier 125 generates metadata (block 930). In the illustrated example, the metadata is generated in an ID3 format. However, any other metadata format may additionally or alternatively be used. Further, in the illustrated example, the metadata is generated based on the extracted metering data (e.g., the metadata may be a textual and/or binary representation of the watermark and/or other metering data). However, in some examples, the metadata may be generated by querying an external source using some or all of the extracted watermark. The media is then transcoded by the transcoder 130 of the service provider 120 (block 940). In the illustrated example, the media is transcoded into an MPEG2 transport stream that may be transmitted via HTTP live streaming (HLS).

The metadata embedder 135 of the service provider 120 embeds the metadata into a manifest file as a fragment identifier (block 950). An example manifest file 610 illustrating an example fragment identifier 725 is shown in FIG. 7. The media and/or the manifest is then transmitted by the media transmitter 140 of the service provider 120 (block 960). In the illustrated example, the media is transmitted using HTTP live streaming (HLS). However, any other format and/or protocol for transmitting (e.g., broadcasting, unicasting, multicasting, streaming, etc.) media may additionally or alternatively be used. In the illustrated example, the media is transmitted in response to a request from the media device 160, 162 based on one or more addresses included in the manifest file.

FIG. 10 is a flowchart representative of example machine-readable instructions 1000 which may be executed to implement the example media monitor 165 of FIG. 1 to monitor network communications. The machine-readable instructions 1000 of FIG. 10 begin execution when the network communicator 505 receives network communications (block 1005). In the illustrated example, the network communicator 505 receives network communications sent from the network gateway 155 to the network 145. However, in some examples, the network communicator 505 also receives network communications sent from the network 145 to the network gateway 155. In the illustrated example, the communications processor 510 inspects the network communications to identify HTTP communications. In some examples, the communications processor 510 inspects the network communications to identify other type(s) and/or protocol(s) of network communication (e.g., HTTP communications, DNS communications, SIP communications, FTP communications, etc.).

The communications processor 510 then inspects the received network communications to determine whether the network communications includes a fragment identifier (block 1010). The fragment identifier is identified based on a delimiter within a requested address. For example, with respect to the first address of FIG. 7, the fragment identifier 725 is delimited from the remainder of the address using a hash (#) mark. However, any other type of delimiter may additionally or alternatively be used. If the network communications does not include a fragment identifier, the network communicator 505 waits for further network communications (block 1005).

Not all fragment identifiers include media-identifying metadata. Normal web usage may result in network communications that include a fragment identifier. For example, if a user were to navigate to the web address “en.wikipedia.org/wiki/The_Nielsen_Company#Company_history” using the HTTP protocol, the fragment identifier “#Company_history” would be identified by the communications processor 510. To account for this issue, the communications processor 510 inspects the fragment identifier to determine whether the fragment identifier includes media-identifying metadata (block 1015.) In the illustrated example, the communications processor 510 makes the determination by determining if the metadata is formatted in a particular format such as, for example, an ID3 format. If the fragment identifier does not include media-identifying metadata, the network communicator 505 waits for further network communications (block 1005).

If the fragment identifier includes media-identifying metadata, the communications are stored in the network communications data store 410 by the communications data storer 515 (block 1020). In some examples, the communications processor 510 inspects the network communications in other fashions prior to storing the network communications. In some examples, the communications processor 510 may identify a source and/or a destination of the network communications. For example, communications might only be stored when they are requests transmitted to particular Internet content providers (e.g., the service provider 120, Netflix®, YouTube®, Hulu®, Pandora®, Last.fm®, etc.) and/or when the communications originated from the media device 160, 162. In some examples, the communications processor 510 processes the received network communications to identify which media device 160, 162 was involved in the network communications. For example, the media device 160, 162 may be identified based on an address such as, for example, an IP address, a MAC address, etc. Furthermore, the communications processor 510 may reduce the amount of storage space required to store the network communications by for example, compressing the fragment identifier, storing only a portion of the fragment identifier, etc.

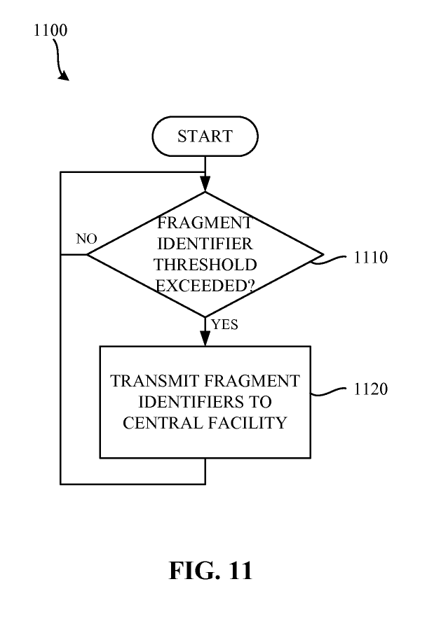

FIG. 11 is a flowchart representative of example machine-readable instructions 1100 which may be executed to implement the example media monitor 165 of FIGS. 1 and/or 5 to transmit stored network communications. The machine-readable instructions 1100 of FIG. 11 begin execution at block 1105 when the communications transmitter 525 determines whether a fragment identifier threshold has been exceeded (block 1105). In the illustrated example, the threshold is a time limit specifying that stored fragment identifiers are transmitted once every day. Additionally or alternatively, any other periodic and/or aperiodic approach to transmitting fragment identifiers from the media monitor 165 may be used. For example, the fragment identifier threshold might be based on an amount of fragment identifiers stored in the network communications data store 520.

If the fragment identifier threshold has not been exceeded (block 1105) the communications transmitter 525 continues to determine whether the network communications have exceeded the fragment identifier threshold. When the fragment identifier threshold has been exceeded (block 1105), the communications transmitter 525 transmits the stored fragment identifiers to the central facility 170 as a log of fragment identifiers. In the illustrated example, the communications transmitter 525 transmits the stored fragment identifier via the network communicator 505. However, in some examples, the communications transmitter 525 transmits the stored network communications via a local connection such as, for example, a serial connection, a universal serial bus (USB) connection, a Bluetooth connection, etc. When the communications transmitter 525 transmits via the local connection, the media monitor 165 may be physically moved to a location of the central facility 170 by, for example, physically mailing the media monitor 165, etc.

FIG. 12 is a flowchart representative of example machine-readable instructions 1200 which may be executed to implement the example central facility 170 of FIG. 1. Initially, the central facility 170 receives people meter data from a people meter at the panelist location (block 1205). In some examples, a people meter collects data identifying people present in the audience of a metered information presentation device such as, for example, the display 162, the media device 160, etc. The people identifying information is used to look up demographics collected from panelists during a registration process. This information is used to statistically project the demographic composition of the audience as a whole.

The central facility 170 receives metadata from one or more media monitors 165 (block 1210). For example, a media monitor 165 may be used in association with a panelist home. Additionally or alternatively, multiple media monitors 165 may be present in a single panelist home. When receiving metadata from the media monitor 165, the central facility 170 records which media monitor 165 the metadata was received from. Such media monitor identifying information may be later used to, for example, identify the panelists associated with the media monitor 165.

The central facility 170 identifies media based on the received metadata (block 1220). In the illustrated example, the metadata represents media exposure information indicative of which users (e.g., panelists) are associated with the media monitor 165. In the illustrated example, the central facility 170 determines demographics of the panelist(s) (block 1230) associated with the media monitor 165 transmitting the metadata. For example, the central facility 170 may look up demographic information based on the geographic location(s) of the identified panelist(s), may look up demographic information provided by the panelist(s), etc.

The example central facility 170 determines media exposure measures (block 1240) based on the metadata received at block 1210 and the people meter data received at block 1205. Timestamps in the people meter data may be used with timestamps in the metadata to correlate specific individual demographics to specific media exposures. In some examples, the central facility 170 determines media exposure metrics based on different demographics associated with the collected media metadata and/or different device types associated with the collected media metadata. The example central facility 170 generates a media exposure report summarizing the media exposure metrics (block 1250).

FIG. 13 is a block diagram of an example processor platform 1300 capable of executing the instructions of FIGS. 8, 9, 10, 11, and/or 12 to implement the example service provider 120, the example media monitor 165, and/or the example central facility 170 of FIGS. 1 and/or 5. The processor platform 1300 can be, for example, a server, a personal computer, an Internet appliance, a network device, a router, a network switch, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1320 of the illustrated example, thus, typically includes a graphics driver card.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

The coded instructions 1332 of FIGS. 8, 9, 10, 11, and/or 12 may be stored in the mass storage device 1328, in the volatile memory 1314, in the non-volatile memory 1316, and/or on a removable tangible computer readable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of measuring exposure to streaming media, the method comprising:
inspecting, with a processor, a HyperText Transfer Protocol (HTTP) request directed to a service provider to determine whether the HTTP request includes a fragment identifier;
extracting media-identifying metadata from the fragment identifier; and
transmitting the media-identifying metadata to a central facility, the central facility at a location different from the service provider.

2. The method as described in claim 1, wherein the HTTP request is an HTTP secure (HTTPS) request.

3. The method as described in claim 1, further comprising determining, in response to the HTTP request including a fragment identifier, whether the fragment identifier includes the media-identifying metadata.

4. The method as described in claim 3, further comprising determining if the fragment identifier is formatted in a metadata format.

5. The method as described in claim 1, further comprising storing the media-identifying metadata in a network communications data store.

6. The method as described in claim 5, wherein the HTTP request is transmitted by a media device, and further comprising:
identifying the media device; and
storing an identifier of the media device in association with the metadata.

7. The method as described in claim 6, wherein the identifier of the media device is a media access control address.

8. The method as described in claim 1, wherein the HTTP request is transmitted by a media device based on a manifest file associated with the requested media.

9. A tangible machine-readable storage medium comprising instructions which, when executed, cause a machine to at least:
inspect a HyperText Transfer Protocol (HTTP) request directed to a service provider to determine whether the HTTP request includes a fragment identifier;
extract media-identifying metadata from the fragment identifier; and
transmit the media-identifying metadata to a central facility, the central facility at a location different from the service provider.

10. The machine-readable medium as described in claim 9, wherein the HTTP request is an HTTP secure (HTTPS) request.

11. The machine-readable medium as described in claim 9, further comprising instructions which, when executed, cause the machine to determine, in response to the HTTP request including a fragment identifier, whether the fragment identifier includes the media-identifying metadata.

12. The machine-readable medium as described in claim 11, further comprising instructions which, when executed cause the machine to determine if the fragment identifier is formatted in a metadata format.

13. The machine-readable medium as described in claim 9, further comprising instructions which, when executed, cause the machine to store the media-identifying metadata in a network communications data store.

14. The machine-readable medium as described in claim 13, wherein the HTTP request is transmitted by a media device, and further comprising instructions which, when executed, cause the machine to at least:
identify the media device; and
store an identifier of the media device in association with the metadata.

15. The machine-readable medium as described in claim 14, wherein the identifier of the media device is a media access control address.

16. The machine-readable medium as described in claim 9, wherein the HTTP request is transmitted by a media device based on a manifest file associated with the requested media.

17. An apparatus to measure exposure to streaming media, the apparatus comprising
a network communicator to monitor a HyperText Transfer Protocol (HTTP) request transmitted by a media device;
a communications processor to inspect the HTTP request to identify whether the HTTP request includes a fragment identifier, the communications processor to extract media-identifying information from the fragment identifier; and
a communications transmitter to transmit the media-identifying metadata to a central facility.

18. The apparatus as described in claim 17, further comprising a communications data storer to store the media-identifying metadata in a memory.

19. The apparatus as described in claim 17, wherein the communications processor is further to identify the media device.

20. The apparatus as described in claim 19, wherein the communications processor is to identify the media device based on a media access control address.

21. A method of monitoring exposure to streaming media, the method comprising:
obtaining a watermark associated with media;
embedding metadata representative of the watermark or data identified by the watermark into a manifest file as a fragment identifier of a universal resource locator, the manifest file to instruct a media device to request the media using the universal resource locator;
inspecting a request for the media to identify the metadata, the request being received from the media device; and
forwarding the metadata to a central facility.

22. The method as described in claim 21, further comprising collecting audience identifying information associated with the media device.

23. The method as described in claim 22, further comprising associating the audience identifying information with the metadata.

24. The method as described in claim 23, further comprising generating a media exposure report based on the audience identifying information and the metadata.

25. A system to measure exposure to streaming media, the system comprising:
a media device to receive a manifest from a service provider, the media device to request media identified in the manifest file by transmitting a HyperText Transfer Protocol (HTTP) request to a URL, the URL including a fragment identifier including metadata based on a watermark associated with the media; and
a media monitor to intercept the HTTP request, the media monitor to extract the metadata from the fragment identifier of the HTTP request.

26. The system as described in claim 25, further comprising a central facility to receive the metadata from the media monitor.

27. The system as described in claim 26, wherein the media monitor is to collect audience identifying information associated with the display and transmit the audience identifying information to the central facility.

28. The system as described in claim 27, wherein the central facility is to generate a media exposure report based on the audience identifying information and the metadata.
